(19) United States
(12) Patent Application Publication
(10) Pub. No.: US 2020/0184565 A1
(43) Pub. Date: Jun. 11, 2020

(54) COMPUTER METHOD FOR REAL ESTATE FUTURES TRADING USING A DISTRIBUTED LEDGER AND GUI

(71) Applicant: ABAXX TECHNOLOGIES INC., Toronto (CA)

(72) Inventors: JOSHUA CRUMB, CHRIST CHURCH (BB); ANDREW FEDAK, CHRIST CHURCH (BB); CHRISTOPHER A. WIKLOF, EVERETT, WA (US)

(21) Appl. No.: 16/708,377

(22) Filed: Dec. 9, 2019

Related U.S. Application Data
(60) Provisional application No. 62/776,595, filed on Dec. 7, 2018.

(51) Int. Cl. G06Q 40/06; G06Q 20/36; H04L 9/06; G06Q 50/16

(52) U.S. Cl. CPC G06Q 40/06; G06Q 20/367; H04L 2209/56; G06Q 50/16; H04L 2209/38; H04L 9/0637

(57) ABSTRACT

A real estate futures smart contract is established and offered via a GUI on an electronic display of a user device and carried by a distributed ledger. The futures contract may be offered for sale on an electronic exchange. The smart contract may carry a price indexed to a real estate futures price schedule.

### CROSS-REFERENCE TO RELATED APPLICATIONS

The present application claims priority benefit from co-pending U.S. Provisional Patent Application No. 62/776,595, entitled “REAL ESTATE FUTURES TRADING USING A DISTRIBUTED LEDGER,” filed Dec. 7, 2018 (docket number 3058-015-02), which application, to the extent not inconsistent with the disclosure herein, is incorporated herein by reference.

### SUMMARY

According to an embodiment, a computer method for establishing a smart futures contract for a real estate future value using a distributed ledger and graphical user interface (GUI) includes establishing, in a computer memory, a location of one or more specified real estate holdings. The computer method includes establishing, in the computer memory, a schedule of nominal value corresponding to the one or more specified real estate holdings, and establishing, in the computer memory, at least one maturity date for trading against the schedule of nominal value. The computer method includes driving a GUI on an electronic display of a user device to display a field including information about a prospective smart futures contract for the one or more specified real estate holdings. The computer method includes receiving, via the GUI from the user, a commit command via a commit object to establish the smart futures contract and creating a smart futures contract corresponding to the one or more specified real estate holdings, the contract including a schedule for future changes in value, and the at least one maturity date.

According to an embodiment, a computer method for establishing a smart futures contract for a real estate future value includes, establishing, in a computer memory, a location of one or more specified real estate holdings. The computer method includes establishing, in the computer memory, a schedule of nominal value corresponding to the one or more specified real estate holdings, and establishing, in the computer memory, at least one maturity date for trading against the schedule. The computer method includes receiving a binding agreement from a party of interest in the one or more specified real estate holdings to offer a futures contract against the schedule, and creating a smart futures contract corresponding to the one or more specified real estate holdings, a schedule for future changes in value, and the at least one maturity date. The computer method includes issuing one or more electronic tokens representing the smart futures contract, recording the smart futures contract and the corresponding one or more electronic tokens onto a distributed ledger, and crediting at least a portion of the issued one or more electronic tokens to an account corresponding to the offering party.

### BRIEF DESCRIPTION OF THE DRAWINGS

FIG. 1 is flow chart showing a computer method for establishing a smart futures contract for a real estate future value using a distributed ledger and graphical user interface (GUI), according to an embodiment.

FIG. 2 is a diagram of a GUI described in conjunction with the computer method of FIG. 1, according to an embodiment.

FIG. 3 is flow chart showing a computer method for establishing a smart futures contract for a real estate future value, according to an embodiment.

FIG. 4 is a flow chart of an additional computer method for establishing a smart futures contract for a real estate future value, according to an embodiment.

FIG. 5 is a block diagram of a computer system configured to administer a commodity material transaction using a distributed ledger, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

As used herein, the term “seller” will be understood to be, as indicated by context, interchangeable with “owner”, “offering party” or “user”. The “seller” will be understood to mean a user with authority to offer a commodity contract for sale, using a smart contract carried by a distributed ledger. The term “buyer” will be understood to be, as indicated by context, interchangeable with “counterparty” or “second user”. The “buyer” will be understood to mean a user with authority to purchase the commodity contract from the “seller”. The inventors contemplate that commodity contracts may be bought and sold multiple times before delivery to an ultimate user, and thus a user who is a “buyer” in a first transaction offering instance may become a “seller” in a second transaction offering instance.

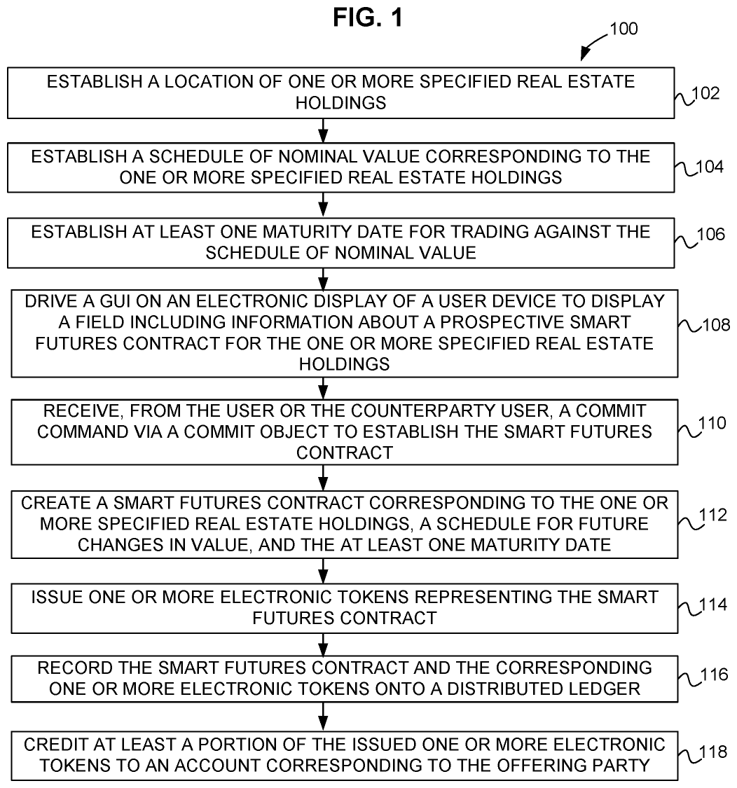

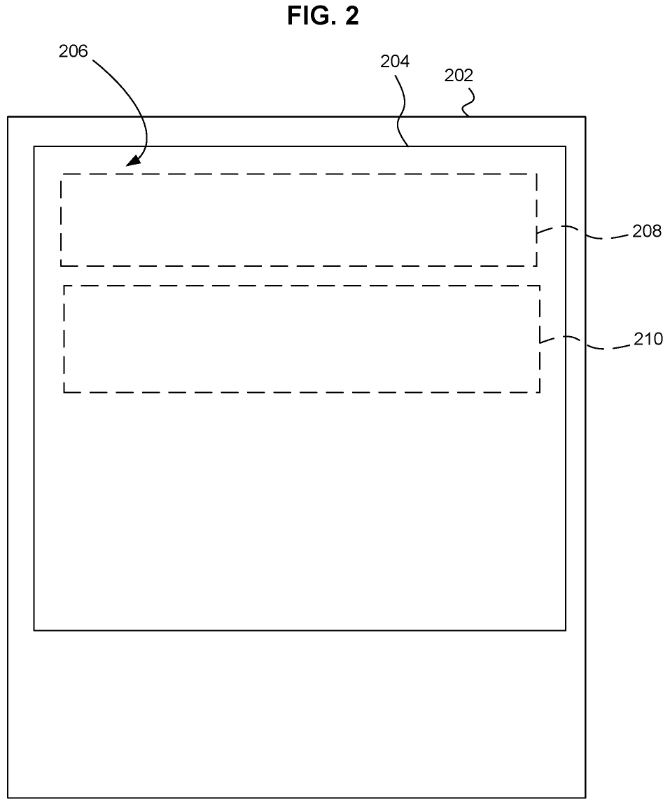

FIG. 1 is flow chart showing a computer method 100 for establishing a smart futures contract for a real estate future value using a distributed ledger and a graphical user interface (GUI), according to an embodiment. FIG. 2 is a diagram of the GUI 206 as described in conjunction with the computer method 100 of FIG. 1, according to an embodiment.

According to an embodiment, referring to FIGS. 1 and 2, a computer method 100 for establishing a smart futures contract for a real estate future value using a distributed ledger and GUI 206 includes, in step 102, establishing, in a computer memory, a location of one or more specified real estate holdings. Step 104 includes establishing, in the computer memory, a schedule of nominal value corresponding to the one or more specified real estate holdings. Step 106 includes establishing, in the computer memory, at least one maturity date for trading against the schedule of nominal value. Step 108 includes driving a GUI 206 on an electronic display 204 of a user device 202 to display a field 208 including information about a prospective smart futures contract for the one or more specified real estate holdings. Step 110 includes receiving, via the GUI 206 from the user, a commit command via a commit object 210 to establish the smart futures contract. Step 112 includes creating a smart futures contract corresponding to the one or more specified real estate holdings, the contract including a schedule for future changes in value, and the at least one maturity date.

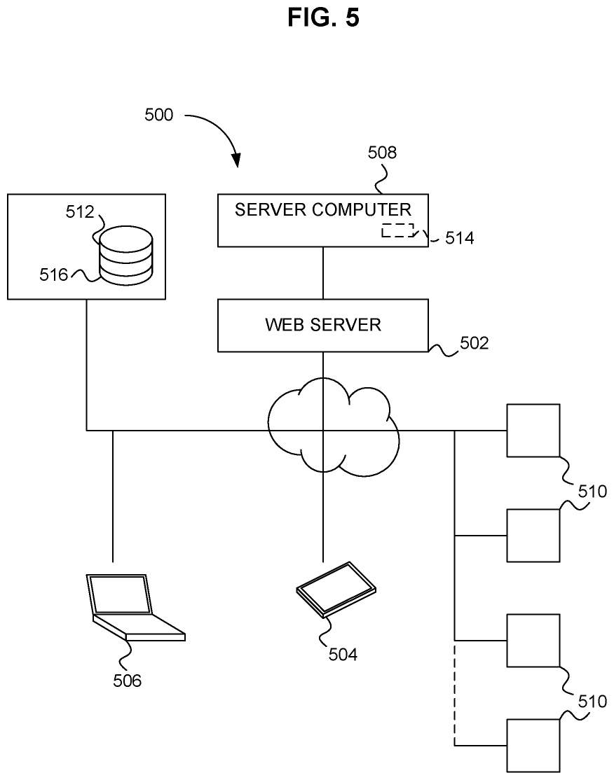

FIG. 5 is a block diagram of a computer system 500 configured to administer a commodity material transaction using a distributed ledger, according to an embodiment. According to an embodiment, referring to FIGS. 1, 2, and 5, the computer method 100 further includes, in step 114, issuing one or more electronic tokens representing the smart futures contract. Step 116 includes recording the smart futures contract and the corresponding one or more electronic tokens onto a distributed ledger. Step 118 includes crediting at least a portion of the issued one or more electronic tokens to an account corresponding to an offering party.

According to an embodiment, crediting at least a portion of the issued one or more electronic tokens to the account corresponding to the offering party, in step 118, includes crediting all the issued one or more electronic tokens, less an amount comprising a fee for creating the electronic tokens, to the account corresponding to the offering party. The offering party may include an owner of the one or more specified real estate holdings. Additionally and/or alternatively, the offering party may include an agent representing one or more owners of the one or more specified real estate holdings.

According to an embodiment, establishing, in the computer memory, the location of one or more specified real estate holdings, in step 102, receiving the location of the one or more specified real estate holdings from the offering party. Receiving the location of the one or more specified real estate holdings from the offering party may include receiving the location of the one or more specified real estate holdings via the GUI 206from the offering party.

According to an embodiment, establishing, in the computer memory, the schedule of nominal value corresponding to the one or more specified real estate holdings, in step 104, includes receiving the schedule of nominal value of the one or more specified real estate holdings from the offering party. Receiving the schedule of nominal value of the one or more specified real estate holdings from the offering party may include receiving the schedule of nominal value of the one or more specified real estate holdings via the GUI 206 from the offering party.

According to an embodiment, establishing, in the computer memory, at least one maturity date for trading against the schedule, in step 106, includes receiving a selection of a single maturity date from a plurality of maturity dates from the offering party. In another embodiment, establishing, in the computer memory, at least one maturity date for trading against the schedule, in step 106, includes automatically generating a single maturity date based on a current date and a selected contract duration.

According to an embodiment, the computer method 100 further includes, in step 110, receiving, via the GUI from the counterparty user, a commit command via a commit object 210 to purchase the smart futures contract. Step 114 includes issuing one or more electronic tokens representing the smart futures contract. Step 116 includes recording the smart futures contract and the corresponding one or more electronic tokens onto a distributed ledger. Step 118 includes crediting at least a portion of the issued one or more electronic tokens to an account corresponding to the counterparty.

According to another embodiment, receiving, via the GUI from the counterparty user, a commit command via a commit object 210, in step 110, to purchase the smart futures contract includes receiving a binding agreement from the counterparty in the one or more specified real estate holdings to buy the futures contract including the schedule of nominal value.

According to an embodiment, the computer method 100 further includes establishing a generic unique description of the one or more specified real estate holdings, wherein the generic unique description of the one or more specified real estate holdings provides an alias for the location. In an embodiment, creating the smart futures contract corresponding to the one or more specified real estate holdings, the schedule for future changes in value, and the at least one maturity date includes creating the smart futures contract corresponding to the generic unique description, the schedule of nominal value, and the at least one maturity date.

According to an embodiment, recording the smart futures contract and the corresponding one or more electronic tokens onto the distributed ledger, in step 116, includes encrypting the location(s) of the one or more specified real estate holdings, encrypting a name of the offering party, and storing the generic unique description, the schedule of nominal value, the at least one maturity date, the encrypted name of the offering party, and the encrypted location(s) as a distributed ledger transaction.

According to an embodiment, the nominal value includes one or more of a future rent, a government assessed value, an appraised value, and a current value adjusted by a third party index.

According to an embodiment, crediting at least the portion of the issued one or more electronic tokens to the account corresponding to the offering party, in step 118, includes listing the issued one or more electronic tokens on an exchange for purchase by investors, and designating the offering party for receipt of at least a portion of funds exchanged for the listed one or more electronic tokens.

According to an embodiment, the computer method 100 further includes listing the issued one or more electronic tokens on an electronic exchange for purchase by a counterparty. The issued one or more electronic tokens may be listed for exchange for one or more electronic currencies. Additionally and/or alternatively, the issued one or more electronic tokens may be listed for exchange for one or more fiat currencies. In one embodiment, listing the issued one or more electronic tokens on the electronic exchange for purchase by the investor includes displaying, on a website, a generic description of the one or more specified real estate holdings in a listing with other electronic tokens available for purchase, the other electronic tokens having similar maturity.

According to an embodiment, the computer method 100 further includes establishing, in the computer memory, an initial discount value from the nominal value, and listing the issued one or more electronic tokens on an electronic exchange for possible purchase at a price equal to the initial discount value.

According to an embodiment, the computer method 100 further includes listing the issued one or more electronic tokens on an electronic exchange for purchase by an investor, swapping the issued one or more electronic tokens for other tokens corresponding to one or more bid prices received from one or more investors, and at the at least one maturity date, receiving data corresponding to an actual value corresponding to the one or more specified real estate holdings. The computer method 100 further includes comparing the actual value to the nominal value corresponding to the one or more specified real estate holdings, calculating a premium or deficit value corresponding to a difference between the nominal value and the actual value, and swapping the issued one or more electronic tokens for other electronic tokens. In one embodiment, swapping the issued one or more electronic tokens for other electronic tokens includes swapping the issued one or more electronic tokens for fractional or greater cryptocurrency tokens. In another embodiment, swapping the issued one or more electronic tokens for other electronic tokens includes swapping the issued one or more electronic tokens for a fiat currency.

In one embodiment, calculating the premium or deficit value includes calculating a premium value corresponding to the one or more specified real estate holdings having a value greater than the nominal value. Swapping the issued one or more electronic tokens for other electronic tokens may include swapping the issued one or more electronic tokens for a positive value of the other electronic tokens. In another embodiment, calculating the premium or deficit value includes calculating a deficit value corresponding to the one or more specified real estate holdings having a value lower than the nominal value. Swapping the issued one or more electronic tokens for other electronic tokens may include receiving the deficit value denominated in the other electronic tokens.

In an embodiment, receiving the deficit value denominated in the other electronic tokens includes performing an electronic transfer of the other tokens from one or more investor margin accounts.

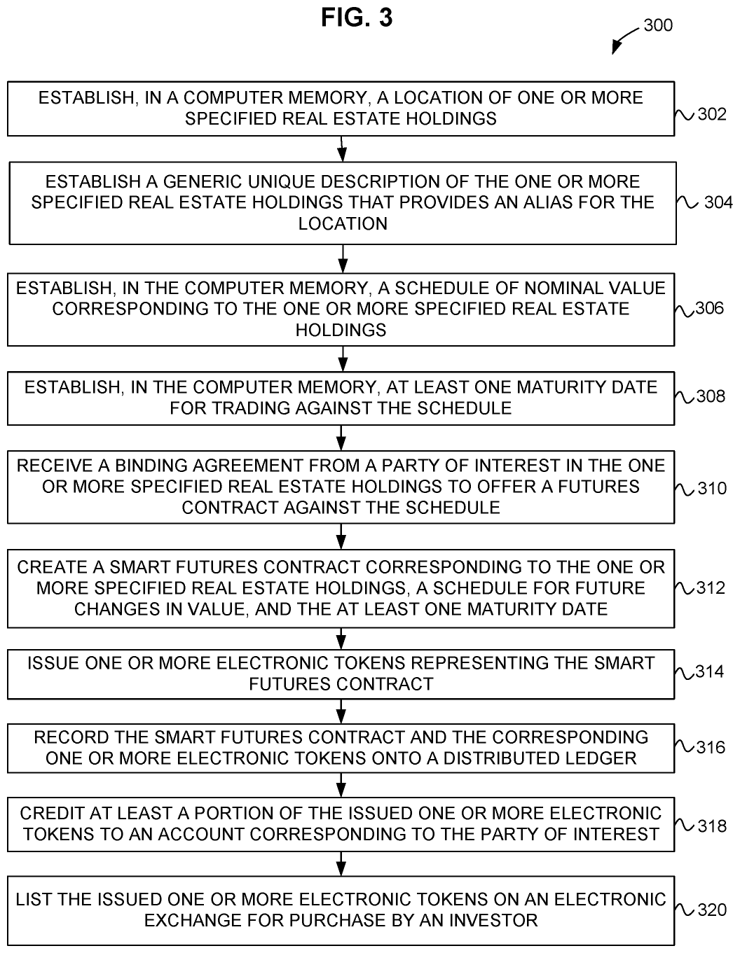

FIG. 3 is flow chart of a computer method 300 for establishing a smart futures contract for a real estate future value, according to an embodiment.

According to an embodiment, the computer method 300 for establishing a smart futures contract for a real estate future value includes, in step 302, establishing, in a computer memory, a location of one or more specified real estate holdings. Step 306 includes establishing, in the computer memory, a schedule of nominal value corresponding to the one or more specified real estate holdings. Step 308 includes establishing, in the computer memory, at least one maturity date for trading against the schedule. Step 310 includes receiving a binding agreement from a offering party in the one or more specified real estate holdings to offer a futures contract against the schedule. Step 312 includes creating a smart futures contract corresponding to the one or more specified real estate holdings, a schedule for future changes in value, and the at least one maturity date. Step 314 includes issuing one or more electronic tokens representing the smart futures contract. Step 316 includes recording the smart futures contract and the corresponding one or more electronic tokens onto a distributed ledger. Step 318 includes crediting at least a portion of the issued one or more electronic tokens to an account corresponding to the offering party.

According to an embodiment, crediting at least a portion of the issued one or more electronic tokens to the account corresponding to the offering party, in step 318, includes crediting all the issued one or more electronic tokens, less an amount comprising a fee for creating the electronic tokens, to the account corresponding to the offering party.

According to an embodiment, the offering party includes an owner of the one or more specified real estate holdings. In another embodiment, the offering party includes an agent representing one or more owners of the one or more specified real estate holdings.

According to an embodiment, establishing, in the computer memory, the location of one or more specified real estate holdings, in step 302, includes receiving the location of the one or more specified real estate holdings from the offering party. In an embodiment, receiving the location of the one or more specified real estate holdings from the offering party includes receiving the location of the one or more specified real estate holdings via a graphical user interface from the offering party.

According to an embodiment, establishing, in the computer memory, the schedule of nominal value corresponding to the one or more specified real estate holdings, in step 306, includes receiving the schedule of nominal value of the one or more specified real estate holdings from the offering party. In an embodiment, receiving the schedule of nominal value of the one or more specified real estate holdings from the offering party includes receiving the schedule of nominal value of the one or more specified real estate holdings via a graphical user interface from the offering party.

According to an embodiment, establishing, in the computer memory, at least one maturity date for trading against the schedule, in step 308, includes receiving a selection of a single maturity date from a plurality of maturity dates from the offering party. In an embodiment, establishing, in the computer memory, at least one maturity date for trading against the schedule, in step 308, includes automatically generating a single maturity date based on a current date and a selected contract duration.

According to an embodiment, the computer method 300 further includes, in step 304, establishing a generic unique description of the one or more specified real estate holdings. The generic unique description of the one or more specified real estate holdings may provide an alias for the location. In an embodiment, referring to steps 304 and 312, creating the smart futures contract corresponding to the one or more specified real estate holdings, the schedule for future changes in value, and the at least one maturity date includes creating the smart futures contract corresponding to the generic unique description, the schedule of nominal value, and the at least one maturity date.

According to an embodiment, recording the smart futures contract and the corresponding one or more electronic tokens onto the distributed ledger, in step 316, includes encrypting the location(s) of the one or more specified real estate holdings, encrypting a name of the offering party, and storing the generic unique description, the schedule of nominal value, the at least one maturity date, the encrypted name of the offering party, and the encrypted location(s) as a distributed ledger transaction.

According to an embodiment, the nominal value includes a future rent. In another embodiment, the nominal value includes a government assessed value. In another embodiment, the nominal value includes an appraised value. In another embodiment, the nominal value includes a current value adjusted by a third party index.

According to an embodiment, crediting at least the portion of the issued one or more electronic tokens to the account corresponding to the offering party, in step 318, includes listing the issued one or more electronic tokens on an exchange for purchase by investors, and designating the offering party for receipt of at least a portion of funds exchanged for the listed one or more electronic tokens.

According to an embodiment, the computer method 300 further includes, in step 320, listing the issued one or more electronic tokens on an electronic exchange for purchase by an investor. In one embodiment, the issued one or more electronic tokens are listed for exchange for one or more electronic currencies. In another embodiment, the issued one or more electronic tokens are listed for exchange for one or more fiat currencies. In an embodiment, listing the issued one or more electronic tokens on the electronic exchange for purchase by the investor, in step 320, includes displaying, on a website, a generic description of the one or more specified real estate holdings in a listing with other electronic tokens available for purchase, the other electronic tokens having similar maturity.

According to an embodiment, the computer method 300 further includes establishing, in the computer memory, an initial discount value from the nominal value, and listing the issued one or more electronic tokens on an electronic exchange for possible purchase at a price equal to the initial discount value.

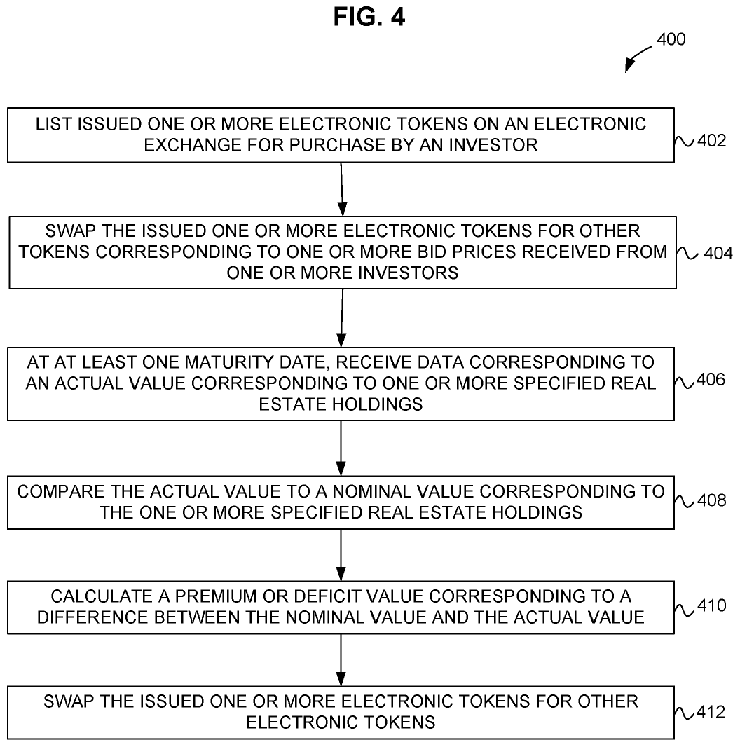

FIG. 4 is a flow chart of an additional computer method 400 for establishing a smart futures contract for a real estate future value, according to an embodiment.

According to an embodiment, the computer method 400 further includes, in step 402, listing issued one or more electronic tokens on an electronic exchange for purchase by an investor. Step 404 includes swapping the issued one or more electronic tokens for other tokens corresponding to one or more bid prices received from one or more investors. Step 406 includes, at least one maturity date, receiving data corresponding to an actual value corresponding to one or more specified real estate holdings. Step 408 includes comparing the actual value to a nominal value corresponding to the one or more specified real estate holdings. Step 410 includes calculating a premium or deficit value corresponding to a difference between the nominal value and the actual value. Step 412 includes swapping the issued one or more electronic tokens for other electronic tokens.

According to an embodiment, in step 412, swapping the issued one or more electronic tokens for other electronic tokens includes swapping the issued one or more electronic tokens for fractional or greater cryptocurrency tokens. In an embodiment, swapping the issued one or more electronic tokens for other electronic tokens includes swapping the issued one or more electronic tokens for a fiat currency.

According to an embodiment, in step 410, calculating the premium or deficit value includes calculating a premium value corresponding to the one or more specified real estate holdings having a value greater than the nominal value. In an embodiment, swapping the issued one or more electronic tokens for other electronic tokens includes swapping the issued one or more electronic tokens for a positive value of the other electronic tokens.

According to an embodiment, in step 410, calculating the premium or deficit value includes calculating a deficit value corresponding to the one or more specified real estate holdings having a value lower than the nominal value. In an embodiment, swapping the issued one or more electronic tokens for other electronic tokens includes receiving the deficit value denominated in the other electronic tokens. In an embodiment, receiving the deficit value denominated in the other electronic tokens includes performing an electronic transfer of the other tokens from one or more investor margin accounts.

FIG. 5 is a block diagram of a computer system 500 configured to administer a commodity material transaction using a distributed ledger, according to an embodiment. As used herein, the term distributed ledger will be understood to include blockchains of various ilks. Illustrated elements described in conjunction with this figure may be described elsewhere herein and may bear dissimilar reference numbers. Corresponding elements will be understood as equivalent as indicated by context.

According to an embodiment, the computer system 500 may include a web server 502 configured to output a first GUI to a first device 504 for a party to receive and display information related to a commodity material transaction smart contract, according to an embodiment. The web server 502 may be further configured to output a second GUI to a second device 506 for a counterparty to receive and display information related to a commodity material transaction smart contract, according to an embodiment. The computer system 500 may include a server computer 508, operatively coupled to the web server 502, and configured to execute data transfer and distributed ledger transactions. The server computer 508 may be further configured to transmit display data to and receive user input from the web server 502, for relay to and from the first and the second devices 504, 506.

According to an embodiment, the computer system 500 may include a plurality of devices 510 operatively coupled to the web server 502 and carrying the distributed ledger. The web server 502 may be configured to transmit the distributed ledger transactions to the plurality of devices 510, according to an embodiment. The plurality of devices 510 may be configured to collectively validate the distributed ledger transactions, according to an embodiment. The web server 502 may be configured to receive and forward collective validation to the server computer 508, according to an embodiment.

According to an embodiment, the server computer 508 may be further configured to transfer a first cryptocurrency and/or digital security associated with commodity transactions corresponding to transactions between a counterparty wallet 512 and a transaction wallet 514 via the web server 502. The server computer 508 may issue a distributed ledger token corresponding to one or more commodity material transactions, according to an embodiment.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer method for establishing a smart futures contract for a real estate future value using a distributed ledger and graphical user interface (GUI), comprising:
establishing, in a computer memory, a location of one or more specified real estate holdings;
establishing, in the computer memory, a schedule of nominal value corresponding to the one or more specified real estate holdings;
establishing, in the computer memory, at least one maturity date for trading against the schedule of nominal value;
driving a GUI on an electronic display of a user device to display a field including information about a prospective smart futures contract for the one or more specified real estate holdings;
receiving, via the GUI from the user, a commit command via a commit object to establish the smart futures contract; and
creating a smart futures contract corresponding to the one or more specified real estate holdings, the contract including a schedule for future changes in value, and the at least one maturity date.

2. The computer method for establishing a smart futures contract for a real estate future value using a distributed ledger and GUI of claim 1 further comprising:
issuing one or more electronic tokens representing the smart futures contract;
recording the smart futures contract and the corresponding one or more electronic tokens onto a distributed ledger; and
crediting at least a portion of the issued one or more electronic tokens to an account corresponding to an offering party.

3. The computer method for establishing a smart futures contract for a real estate future value using a distributed ledger and GUI of claim 2, wherein crediting at least a portion of the issued one or more electronic tokens to the account corresponding to the offering party includes crediting all the issued one or more electronic tokens, less an amount comprising a fee for creating the electronic tokens, to the account corresponding to the offering party.

4. The computer method for establishing a smart futures contract for a real estate future value using a distributed ledger and GUI of claim 2, wherein the offering party includes an owner of the one or more specified real estate holdings.

5. The computer method for establishing a smart futures contract for a real estate future value using a distributed ledger and GUI of claim 2, wherein the offering party includes an agent representing one or more owners of the one or more specified real estate holdings.

6. The computer method for establishing a smart futures contract for a real estate future value using a distributed ledger and GUI of claim 2, wherein establishing, in the computer memory, the location of one or more specified real estate holdings comprises:
receiving the location of the one or more specified real estate holdings from the offering party.

7. The computer method for establishing a smart futures contract for a real estate future value using a distributed ledger and GUI of claim 6, wherein receiving the location of the one or more specified real estate holdings from the offering party comprises:
receiving the location of the one or more specified real estate holdings via a graphical user interface from the offering party.

8. The computer method for establishing a smart futures contract for a real estate future value using a distributed ledger and GUI of claim 2, wherein establishing, in the computer memory, the schedule of nominal value corresponding to the one or more specified real estate holdings comprises:
receiving the schedule of nominal value of the one or more specified real estate holdings from the offering party.

9. The computer method for establishing a smart futures contract for a real estate future value using a distributed ledger and GUI of claim 8, wherein receiving the schedule of nominal value of the one or more specified real estate holdings from the offering party comprises:
receiving the schedule of nominal value of the one or more specified real estate holdings via a graphical user interface from the offering party.

10. The computer method for establishing a smart futures contract for a real estate future value using a distributed ledger and GUI of claim 1, wherein establishing, in the computer memory, at least one maturity date for trading against the schedule comprises:
receiving a selection of a single maturity date from a plurality of maturity dates from the offering party.

11. The computer method for establishing a smart futures contract for a real estate future value using a distributed ledger and GUI of claim 1, wherein establishing, in the computer memory, at least one maturity date for trading against the schedule comprises:
automatically generating a single maturity date based on a current date and a selected contract duration.

12. The computer method for establishing a smart futures contract for a real estate future value using a distributed ledger and GUI of claim 11 further comprising:
receiving, via the GUI from the counterparty user, a commit command via a commit object to purchase the smart futures contract;
issuing one or more electronic tokens representing the smart futures contract;
recording the smart futures contract and the corresponding one or more electronic tokens onto a distributed ledger; and
crediting at least a portion of the issued one or more electronic tokens to an account corresponding to the counterparty.

13. The computer method for establishing a smart futures contract for a real estate future value using a distributed ledger and GUI of claim 12 wherein receiving, via the GUI from the counterparty user, a commit command via a commit object to purchase the smart futures contract comprises:
receiving a binding agreement from the counterparty in the one or more specified real estate holdings to buy the futures contract including the schedule of nominal value.

14. The computer method for establishing a smart futures contract for a real estate future value using a distributed ledger and GUI of claim 1, further comprising:
establishing a generic unique description of the one or more specified real estate holdings, wherein the generic unique description of the one or more specified real estate holdings provides an alias for the location; and
wherein creating the smart futures contract corresponding to the one or more specified real estate holdings, the schedule for future changes in value, and the at least one maturity date comprises:
creating the smart futures contract corresponding to the generic unique description, the schedule of nominal value, and the at least one maturity date.

15. The computer method for establishing a smart futures contract for a real estate future value using a distributed ledger and GUI of claim 14, wherein recording the smart futures contract and the corresponding one or more electronic tokens onto the distributed ledger comprises:
encrypting the location(s) of the one or more specified real estate holdings;
encrypting a name of the offering party; and
storing the generic unique description, the schedule of nominal value, the at least one maturity date, the encrypted name of the offering party, and the encrypted location(s) as a distributed ledger transaction.

16. The computer method for establishing a smart futures contract for a real estate future value using a distributed ledger and GUI of claim 1, wherein the nominal value comprises a future rent.

17. The computer method for establishing a smart futures contract for a real estate future value using a distributed ledger and GUI of claim 1, wherein the nominal value comprises a government assessed value.

18. The computer method for establishing a smart futures contract for a real estate future value using a distributed ledger and GUI of claim 1, wherein the nominal value comprises an appraised value.

19. The computer method for establishing a smart futures contract for a real estate future value using a distributed ledger and GUI of claim 1, wherein the nominal value comprises a current value adjusted by a third party index.

20. The computer method for establishing a smart futures contract for a real estate future value using a distributed ledger and GUI of claim 1, wherein crediting at least the portion of the issued one or more electronic tokens to the account corresponding to the offering party comprises:
listing the issued one or more electronic tokens on an exchange for purchase by investors; and
designating the offering party for receipt of at least a portion of funds exchanged for the listed one or more electronic tokens.

21. The computer method for establishing a smart futures contract for a real estate future value using a distributed ledger and GUI of claim 1, further comprising:
listing the issued one or more electronic tokens on an electronic exchange for purchase by a counterparty.

22. The computer method for establishing a smart futures contract for a real estate future value using a distributed ledger and GUI of claim 21, wherein the issued one or more electronic tokens are listed for exchange for one or more electronic currencies.

23. The computer method for establishing a smart futures contract for a real estate future value using a distributed ledger and GUI of claim 21, wherein the issued one or more electronic tokens are listed for exchange for one or more fiat currencies.

24. The computer method for establishing a smart futures contract for a real estate future value using a distributed ledger and GUI of claim 21, wherein listing the issued one or more electronic tokens on the electronic exchange for purchase by the investor comprises:
displaying, on a website, a generic description of the one or more specified real estate holdings in a listing with other electronic tokens available for purchase, the other electronic tokens having similar maturity.

25. The computer method for establishing a smart futures contract for a real estate future value using a distributed ledger and GUI of claim 1, further comprising:
establishing, in the computer memory, an initial discount value from the nominal value; and
listing the issued one or more electronic tokens on an electronic exchange for possible purchase at a price equal to the initial discount value.

26. The computer method for establishing a smart futures contract for a real estate future value using a distributed ledger and GUI of claim 1, further comprising:
listing the issued one or more electronic tokens on an electronic exchange for purchase by an investor;
swapping the issued one or more electronic tokens for other tokens corresponding to one or more bid prices received from one or more investors;
at the at least one maturity date, receiving data corresponding to an actual value corresponding to the one or more specified real estate holdings;
comparing the actual value to the nominal value corresponding to the one or more specified real estate holdings;
calculating a premium or deficit value corresponding to a difference between the nominal value and the actual value; and
swapping the issued one or more electronic tokens for other electronic tokens.

27. The computer method for establishing a smart futures contract for a real estate future value using a distributed ledger and GUI of claim 26, wherein swapping the issued one or more electronic tokens for other electronic tokens comprises swapping the issued one or more electronic tokens for fractional or greater cryptocurrency tokens.

28. The computer method for establishing a smart futures contract for a real estate future value using a distributed ledger and GUI of claim 26, wherein swapping the issued one or more electronic tokens for other electronic tokens comprises swapping the issued one or more electronic tokens for a fiat currency.

29. The computer method for establishing a smart futures contract for a real estate future value using a distributed ledger and GUI of claim 26, wherein calculating the premium or deficit value comprises calculating a premium value corresponding to the one or more specified real estate holdings having a value greater than the nominal value; and
wherein swapping the issued one or more electronic tokens for other electronic tokens comprises swapping the issued one or more electronic tokens for a positive value of the other electronic tokens.

30. The computer method for establishing a smart futures contract for a real estate future value using a distributed ledger and GUI of claim 26, wherein calculating the premium or deficit value comprises calculating a deficit value corresponding to the one or more specified real estate holdings having a value lower than the nominal value; and
wherein swapping the issued one or more electronic tokens for other electronic tokens comprises receiving the deficit value denominated in the other electronic tokens.

31. The computer method for establishing a smart futures contract for a real estate future value using a distributed ledger and GUI of claim 1, wherein receiving the deficit value denominated in the other electronic tokens comprises performing an electronic transfer of the other tokens from one or more investor margin accounts.

32. A computer method for establishing a smart futures contract for a real estate future value, comprising:
establishing, in a computer memory, a location of one or more specified real estate holdings;
establishing, in the computer memory, a schedule of nominal value corresponding to the one or more specified real estate holdings;
establishing, in the computer memory, at least one maturity date for trading against the schedule;
receiving a binding agreement from a party of interest in the specified one or more real estate holdings to offer a futures contract against the schedule;
creating a smart futures contract corresponding to the specified one or more real estate holdings, the schedule for future changes in value, and the at least one maturity date;
issuing one or more electronic tokens representing the smart futures contract;
recording the smart futures contract and the corresponding one or more electronic tokens onto a distributed ledger; and
crediting at least a portion of the issued one or more electronic tokens to an account corresponding to the party of interest.

33. The computer method for establishing a smart futures contract for a real estate future value of claim 32, wherein crediting at least a portion of the issued one or more electronic tokens to the account corresponding to the party of interest includes crediting all the issued one or more electronic tokens, less an amount comprising a fee for creating the electronic tokens, to the account corresponding to the party of interest.

34. The computer method for establishing a smart futures contract for a real estate future value of claim 32, wherein the party of interest includes an owner of the one or more specified real estate holdings.

35. The computer method for establishing a smart futures contract for a real estate future value of claim 32, wherein the party of interest includes an agent representing one or more owners of the one or more specified real estate holdings.

36. The computer method for establishing a smart futures contract for a real estate future value of claim 32, wherein establishing, in the computer memory, the location of one or more specified real estate holdings comprises:
receiving the location of the one or more specified real estate holdings from the party of interest.

37. The computer method for establishing a smart futures contract for a real estate future value of claim 36, wherein receiving the location of the one or more specified real estate holdings from the party of interest comprises:
receiving the location of the one or more specified real estate holdings via a graphical user interface from the party of interest.

38. The computer method for establishing a smart futures contract for a real estate future value of claim 32, wherein establishing, in the computer memory, the schedule of nominal value corresponding to the one or more specified real estate holdings comprises:
receiving the schedule of nominal value of the one or more specified real estate holdings from the party of interest.

39. The computer method for establishing a smart futures contract for a real estate future value of claim 38, wherein receiving the schedule of nominal value of the one or more specified real estate holdings from the party of interest comprises:
receiving the schedule of nominal value of the one or more specified real estate holdings via a graphical user interface from the party of interest.

40. The computer method for establishing a smart futures contract for a real estate future value of claim 32, wherein establishing, in the computer memory, at least one maturity date for trading against the schedule comprises:
receiving a selection of a single maturity date from a plurality of maturity dates from the party of interest.

41. The computer method for establishing a smart futures contract for a real estate future value of claim 32, wherein establishing, in the computer memory, at least one maturity date for trading against the schedule comprises:
automatically generating a single maturity date based on a current date and a selected contract duration.

42. The computer method for establishing a smart futures contract for a real estate future value of claim 32, further comprising:
establishing a generic unique description of the one or more specified real estate holdings, wherein the generic unique description of the one or more specified real estate holdings provides an alias for the location; and
wherein creating the smart futures contract corresponding to the specified one or more real estate holdings, the schedule for future changes in value, and the at least one maturity date comprises:
creating the smart futures contract corresponding to the generic unique description, the schedule of nominal value, and the at least one maturity date.

43. The computer method for establishing a smart futures contract for a real estate future value of claim 42, wherein recording the smart futures contract and the corresponding one or more electronic tokens onto the distributed ledger comprises:
encrypting the location(s) of the specified one or more real estate holdings;
encrypting a name of the party of interest; and
storing the generic unique description, the schedule of nominal value, the at least one maturity date, the encrypted name of the party of interest, and the encrypted location(s) as a distributed ledger transaction.

44. The computer method for establishing a smart futures contract for a real estate future value of claim 32, wherein the nominal value comprises a future rent.

45. The computer method for establishing a smart futures contract for a real estate future value of claim 32, wherein the nominal value comprises a government assessed value.

46. The computer method for establishing a smart futures contract for a real estate future value of claim 32, wherein the nominal value comprises an appraised value.

47. The computer method for establishing a smart futures contract for a real estate future value of claim 32, wherein the nominal value comprises a current value adjusted by a third party index.

48. The computer method for establishing a smart futures contract for a real estate future value of claim 32, wherein crediting at least the portion of the issued one or more electronic tokens to the account corresponding to the party of interest comprises:
listing the issued one or more electronic tokens on an exchange for purchase by investors; and
designating the party of interest for receipt of at least a portion of funds exchanged for the listed one or more electronic tokens.

49. The computer method for establishing a smart futures contract for a real estate future value of claim 32, further comprising:
listing the issued one or more electronic tokens on an electronic exchange for purchase by an investor.

50. The computer method for establishing a smart futures contract for a real estate future value of claim 49, wherein the issued one or more electronic tokens are listed for exchange for one or more electronic currencies.

51. The computer method for establishing a smart futures contract for a real estate future value of claim 49, wherein the issued one or more electronic tokens are listed for exchange for one or more fiat currencies.

52. The computer method for establishing a smart futures contract for a real estate future value of claim 49, wherein listing the issued one or more electronic tokens on the electronic exchange for purchase by the investor comprises:
displaying, on a website, a generic description of the one or more specified real estate holdings in a listing with other electronic tokens available for purchase, the other electronic tokens having similar maturity.

53. The computer method for establishing a smart futures contract for a real estate future value of claim 32, further comprising establishing, in the computer memory, an initial discount value from the nominal value; and
further comprising listing the issued one or more electronic tokens on an electronic exchange for possible purchase at a price equal to the initial discount value.

54. The computer method for establishing a smart futures contract for a real estate future value of claim 32, further comprising:
listing the issued one or more electronic tokens on an electronic exchange for purchase by an investor;
swapping the issued one or more electronic tokens for other tokens corresponding to one or more bid prices received from one or more investors;
at the at least one maturity date, receiving data corresponding to an actual value corresponding to the one or more specified real estate holdings;
comparing the actual value to the nominal value corresponding to the one or more specified real estate holdings;
calculating a premium or deficit value corresponding to a difference between the nominal value and the actual value; and
swapping the issued one or more electronic tokens for other electronic tokens.

55. The computer method for establishing a smart futures contract for a real estate future value of claim 54, wherein swapping the issued one or more electronic tokens for other electronic tokens comprises swapping the issued one or more electronic tokens for fractional or greater cryptocurrency tokens.

56. The computer method for establishing a smart futures contract for a real estate future value of claim 54, wherein swapping the issued one or more electronic tokens for other electronic tokens comprises swapping the issued one or more electronic tokens for a fiat currency.

57. The computer method for establishing a smart futures contract for a real estate future value of claim 54, wherein calculating the premium or deficit value comprises calculating a premium value corresponding to the one or more real estate holdings having a value greater than the nominal value; and
wherein swapping the issued one or more electronic tokens for other electronic tokens comprises swapping the issued one or more electronic tokens for a positive value of the other electronic tokens.

58. The computer method for establishing a smart futures contract for a real estate future value of claim 54, wherein calculating the premium or deficit value comprises calculating a deficit value corresponding to the one or more real estate holdings having a value lower than the nominal value; and
wherein swapping the issued one or more electronic tokens for other electronic tokens comprises receiving the deficit value denominated in the other electronic tokens.

59. The computer method for establishing a smart futures contract for a real estate future value of claim 32, wherein receiving the deficit value denominated in the other electronic tokens comprises performing an electronic transfer of the other tokens from one or more investor margin accounts.
